(19) United States
(12) Patent Application Publication
(10) Pub. No.: US 2017/0164608 A1
(43) Pub. Date: Jun. 15, 2017

(54) Pesticide Ointment and Preparation Method Thereof

(71) Applicant: NEK Chemicals Limited, Hong Kong (HK)

(72) Inventor: Wing Ngai Ng, Hong Kong (HK)

(21) Appl. No.: 15/348,975

(22) Filed: Nov. 10, 2016

(30) Foreign Application Priority Data
Dec. 9, 2015 (CN) 201510904048.X

(51) Int. Cl. A01N 25/08; A01N 57/20; A01N 43/653; A01N 43/50; A01N 53/00; A01N 43/54

(52) U.S. Cl. CPC A01N 25/08; A01N 53/00; A01N 43/54; A01N 43/653; A01N 43/50; A01N 57/20

(57) ABSTRACT

The present invention relates to a kind of pesticide ointment and applying device thereof. The pesticide ointment comprises 15-30 parts of solid wax used as a carrier, 20-40 parts of pasty grease, 20-50 parts of liquid oil and 0.5-20 parts of pesticide serving as an active ingredient. The present invention further provides a preparation method of the foregoing ointment. The pesticide ointment provided by the present invention uses soft wax as a main carrier, contains different types of pesticides as active ingredients and can actively suppress fungi, kill pests and remove weeds. As it is a solid preparation, the ointment may be smeared on the target positions and will not contaminate non-target positions.

### CROSS REFERENCE TO RELATED APPLICATIONS

The present application claims the benefit of Chinese Patent Application No. 201510904048.X filed on Dec. 9, 2015. All the above are hereby incorporated by reference.

### TECHNICAL FIELD

The present invention relates to the technical field of plant protection and hygienic pest control, particularly to a kind of pesticide ointment and preparation method thereof.

### DESCRIPTION OF THE BACKGROUND

Currently, common pesticide products are mostly in a liquid or semisolid state. Liquid pesticide is packed in a spray can. During use, it may be sprayed out under the propulsion of compressed gas. As the sprayed gas is mostly combustible and is sprayed out in mist, the product has potential hazards of combustion and explosion and will also contaminate non-target positions due to inaccurate targeting.

Semisolid pesticide does not have a fixed shape and generally is packed in a squeezable tube or a hard package with a cylinder. During use, the tube is squeezed or a piston is pushed to squeeze the ointment in the cylinder. The extruded ointment will stay at the release position by relying on its own adhesive force. However, this product is mostly used for hygienic pest control and the use is singular. Further, as it is a semisolid ointment, if the package is wrongly squeezed or the application is not careful, ointment may fall to non-target surface, causing contamination.

There are some products for plant wound care. One of the methods is to cover plant wounds with wax to isolate the wounds from the outside world and play a protective role, but in this method, no appropriate pesticide is added and the care effect is poor; another wound care product containing pesticide is a coating similar to paint preparation. During application, this paint preparation is smeared on the target object, but as it is a liquid product, it is liable to splash and contamination of non-target surface.

### SUMMARY OF THE INVENTION

To address the foregoing defects or shortcomings of prior art, the object of the present invention is to provide a kind of pesticide ointment and applying device thereof.

In order to realize the foregoing object, the present invention adopts the following technical scheme:

On the one hand, the present invention provides a pesticide ointment, comprising:

| | | |
|---|---|---|
| Solid wax used as a carrier | 15-30 | parts, |
| Pasty grease | 20-40 | parts, |
| Liquid oil | 20-50 | parts; and, |
| Pesticide serving as | 0.5-20 | parts |
| an active ingredient | | |

As a modification scheme, the pesticide is insecticide. The content of the insecticide calculated based on part by weight is 0.5-5 parts. The pesticide further comprises additive alluring pests, and bait alluring and killing pests.

As a modification scheme, the pesticide is expelling insecticide. The content of the insecticide calculated based on part by weight is 0.5-5 parts. The insecticide is intended to expel pests.

As a modification scheme, the pesticide is fungicide. The content of the fungicide calculated based on part by weight is 0.5-5 parts. The fungicide is intended to eliminate fungi.

As a modification scheme, the pesticide is a mixture of fungicide and insecticide. The content of the mixture of fungicide and insecticide calculated based on part by weight is 0.5-5 parts. The mixture is intended to eliminate pests and fungi.

As a modification scheme, the pesticide is herbicide. The content of the herbicide calculated based on part by weight is 2-20 parts. The herbicide is intended to eliminate weeds and heterozygous plants.

As a modification scheme, the pesticide further comprises surface active agent, suspending agent and other stabilizing agents for maintaining stability. The content of the stabilizing agents calculated based on part by weight is 0-20 parts.

As a modification scheme, the pesticide further comprises pigment serving as a carrier, and the content of the pigment calculated based on part by weight is 0-2 parts.

On the other hand, the present invention provides a method for preparing pesticide ointment, including the following steps:

mixing pasty grease and pesticide to obtain a premix;

adding solid wax into liquid oil, melting it by heating to obtain a wax oil liquid and then cooling the wax oil liquid to above solidifying point;

adding the obtained premix into cooled wax oil liquid, mixing it evenly and then cooling and condensing the mixture into paste to obtain the pesticide ointment.

As a modification scheme, the step of preparing premix further includes adding powdery pigment, stabilizing agents and/or additives alluring pests.

The foregoing obtained ointment will not be melted and will remain its shape below ambient temperature 40° C.; further, after the ointment with certain lubricity is filled into a packaging container (ointment tube or dedicated pesticide applying tool), it may smoothly enter or leave the packing container under the action of an external force; meanwhile, the ointment per se is not liable to releasing oily ingredients, thereby avoiding oily substances spilling from the packing container and affecting the storage and use of the ointment; further, the ointment per se is viscous and can cling to the applying position after it is smeared on the target object, even some smooth surfaces.

Compared to prior art, the pesticide ointment provided by the present invention uses soft wax as a major carrier and contains different pesticides (fungicide, insecticide and/or herbicide) as active ingredients. The pesticide ointment can effectively kill fungi and pests and eliminate weeds. It is a solid preparation and may be smeared to the target positions without contaminating non-target positions. It is characterized by safe use, simple structure, convenient operation, easy storage and portability.

### DETAILED DESCRIPTION OF PREFERRED EMBODIMENTS

Below the technical scheme of the present invention is described in details by referring to embodiments. In all embodiments, pesticide ointment is prepared by the following method: mixing pasty grease and pesticide to obtain a premix; adding solid wax into liquid oil, melting it by heating to obtain a wax oil liquid and then cooling the wax oil liquid to above solidifying point; adding the obtained premix into cooled wax oil liquid, mixing it evenly and then cooling and condensing the mixture into paste to obtain the pesticide ointment.

As a modification scheme, the step of preparing premix further includes adding powdery pigment, stabilizing agents and/or additives alluring pests.

### Embodiment 1

The pesticide ointment is pesticide with insecticide as an active ingredient. It uses solid wax, pasty grease, liquid oil and pigment as carriers and contains an appropriate amount of stabilizing agent. The content of each component calculated based on part by weight is respectively: solid wax 15-30 parts, pasty grease 20-40 parts, liquid oil 20-50 parts, pigment 0.1-2 parts, stabilizing agent 0.1-10 parts and insecticide 0.5-5 parts. The melting point of the solid wax is 60° C. or above, such as: beeswax; the drop melting point of the pasty grease is 40° C. or above, such as: vaseline; the melting point of the liquid oil is 0° C. or above, such as: corn oil; the soft wax ingredient synthesized by solid wax, pasty grease and liquid oil is hardly volatile, has certain adhesive capacity and makes the ointment cling to the applying position. The insecticide is imidacloprid, abamectin, fipronil or others. The pesticide ointment containing this insecticide may be smeared in the locations haunted by pests to reduce and kill passing pests.

In this embodiment, sugar, milk powder or insect pheromone and other additives alluring pests may be added. Such additives may be used as baits to allure pests to approach the ointment, thereby achieving the effect of killing and eliminating pests;

In this embodiment, in order to more easily identify whether the ointment has been applied in the smeared positions, pigment is added to the carrier. The stabilizing agent is interface agent, suspending agent and other substances that can prevent decomposition and aging of the ointment.

### Embodiment 2

The pesticide ointment is pesticide using expelling insecticide as an active ingredient. It uses solid wax, pasty grease, liquid oil and pigment as carriers and contains an appropriate amount of stabilizing agent. The content of each component calculated based on part by weight is respectively: solid wax 15-30 parts, pasty grease 20-40 parts, liquid oil 20-50 parts, pigment 0.1-2 parts, stabilizing agent 0.1-10 parts and expelling insecticide 0.5-5 parts. The melting point of the solid wax is 60° C. or above, such as: beeswax; the drop melting point of the pasty grease is 40° C. or above, such as: vaseline; the melting point of the liquid oil is 0° C. or above, such as: corn oil; the soft wax ingredient synthesized by solid wax, pasty grease and liquid oil is hardly volatile, has certain adhesive capacity and makes the ointment cling to the applying position.

In this embodiment, pyrethroid and other agents having an expelling effect are added. The ointment may be smeared on the paths of activities of pests and keep pests (cockroaches, flies, mosquitoes, termites, etc.) away from the pesticide applying positions.

In this embodiment, in order to more easily identify whether the ointment has been applied in the smeared positions, pigment is added to the carrier. The stabilizing agent is surface active agent, suspending agent and other substances that can prevent decomposition and aging of the ointment.

### Embodiment 3

The pesticide ointment is pesticide with fungicide as an active ingredient. It uses solid wax, pasty grease, liquid oil and pigment as carriers and contains an appropriate amount of stabilizing agent. The content of each component calculated based on part by weight is respectively: solid wax 15-30 parts, pasty grease 20-40 parts, liquid oil 20-50 parts, pigment 0.1-2 parts, stabilizing agent 10-20 parts and fungicide 0.5-5 parts. The melting point of the solid wax is 60° C. or above, such as: beeswax; the drop melting point of the pasty grease is 40° C. or above, such as: vaseline; the melting point of the liquid oil is 0° C. or above, such as: corn oil; the soft wax ingredient synthesized by solid wax, pasty grease and liquid oil is hardly volatile, has certain adhesive capacity and makes the ointment cling to the applying position.

The fungicide is broad spectrum fungicide (such as: azoxystrobin and propiconazole). It is smeared on plant surfaces and wounds where hypha or live mushroom grows out or which are infested with fungi, and can stop the spread of fungi and treat plant wounds infected with fungi. Some fungicide (such as: chlorothalonil and carbendazim) have very low toxicity to mammals, so the ointment containing such bactericide may be smeared on wooden structures frequently affected by moist (such as: roots of porches or timber piles connecting the ground) to play an effect of killing and reducing fungi and preventing mildew.

### Embodiment 4

The pesticide ointment is pesticide with the mixture of fungicide and insecticide as an active ingredient. It uses solid wax, pasty grease, liquid oil and pigment as carriers and contains an appropriate amount of stabilizing agent. The content of each component calculated based on part by weight is respectively: solid wax 15-30 parts, pasty grease 20-40 parts, liquid oil 20-50 parts, pigment 0.1-2 parts, stabilizing agent 0.1-10 parts, and fungicide and insecticide 0.5-5 parts. The melting point of the solid wax is 60° C. or above, such as: beeswax; the drop melting point of the pasty grease is 40° C. or above, such as: vaseline; the melting point of the liquid oil is 0° C. or above, such as: corn oil; the soft wax ingredient synthesized by solid wax, pasty grease and liquid oil is hardly volatile, has certain adhesive capacity and makes the ointment cling to the applying position.

The pesticide ointment contains systemic insecticide (such as: imidacloprid) and fungicide (such as: azoxystrobin) and may be used as plant wound care ointment. After the ointment is smeared on plant wounds, the plant wounds are covered with soft wax to avoid water drain, dryness and fracturing of the wounds. Meanwhile, the mixture of systemic insecticide and fungicide is absorbed by plants to protect the plant issues near the wounds from encroachment by fungi and pests and make plant wounds heal spontaneously under a favorable condition. If there are pests on the wounds already, the mixture of systemic insecticide and fungicide can also play a therapeutic role.

### Embodiment 5

The pesticide ointment is pesticide with herbicide as an active ingredient. It uses solid wax, pasty grease and liquid oil as carriers. Subject to the actual condition, an appropriate amount of stabilizing agent and pigment may be added optionally. The content of each component calculated based on part by weight is respectively: solid wax 15-30 parts, pasty grease 20-40 parts, liquid oil 20-50 parts, pigment 0-2 parts, stabilizing agent 0-10 parts and herbicide 2-20 parts. The melting point of the solid wax is 60° C. or above, such as: beeswax; the drop melting point of the pasty grease is 40° C. or above, such as: vaseline; the melting point of the liquid oil is 0° C. or above, such as: corn oil; the soft wax ingredient synthesized by solid wax, pasty grease and liquid oil is hardly volatile, has certain adhesive capacity and makes the ointment cling to the applying position.

The herbicide may be glyphosate for example. After the ointment containing glyphosate is smeared on plant surface or artificial wounds of target plants, active ingredient glyphosate will infiltrate into the plants and destroy the growth function of the plants. As smearing solid ointment is adopted, it may selectively eliminate target plants without affecting the plants that need to be protected.

The foregoing embodiments are only a few embodiments of the present invention. Their descriptions are concrete and detailed, but they shall not be therefore understood as limitations to the scope of the present invention patent. It shall be noted that for those skilled in the art, various changes and modifications may be made to the embodiments without departing from the spirit of the present invention, such as: combinations of different features of the embodiments. All these shall be in the protective scope of the present invention.

What is claimed is:

1. A pesticide ointment, comprising:

| | | |
|---|---|---|
| solid wax used as a carrier | 15-30 | parts, |
| pasty grease | 20-40 | parts, |
| liquid oil | 20-50 | parts; and, |
| pesticide serving as | 0.5-20 | parts. |
| an active ingredient | | |

2. The pesticide ointment according to claim 1, wherein the pesticide is insecticide; the content of the insecticide calculated based on part by weight being 0.5-5 parts; the pesticide further comprising additive alluring pests, and bait alluring and killing pests.

3. The pesticide ointment according to claim 1, wherein the pesticide is expelling insecticide; the content of the insecticide calculated based on part by weight being 0.5-5 parts; the insecticide being intended to expel pests.

4. The pesticide ointment according to claim 1, wherein the pesticide is fungicide; the content of the fungicide calculated based on part by weight being 0.5-5 parts; the fungicide being intended to eliminate fungi.

5. The pesticide ointment according to claim 1, wherein the pesticide is a mixture of fungicide and insecticide; the content of the mixture of fungicide and insecticide calculated based on part by weight being 0.5-5 parts; the mixture being intended to eliminate insect pests and fungi.

6. The pesticide ointment according to claim 1, wherein the pesticide is herbicide; the content of the herbicide calculated based on part by weight being 2-20 parts; the herbicide being intended to eliminate weeds and heterozygous plants.

7. The pesticide ointment according to claim 1, wherein the pesticide ointment further comprises surface active agent, suspending agent and other stabilizing agents for maintaining stability; the content of the stabilizing agents calculated based on part by weight being 0-20 parts.

8. The pesticide ointment according to claim 1, wherein the pesticide ointment further comprises pigment serving as a carrier; the content of the pigment calculated based on part by weight being 0-2 parts.

9. A method for preparing the pesticide ointment of claim 1, including the following steps:
mixing pasty grease and pesticide to obtain a premix;
adding solid wax into liquid oil, melting it by heating to obtain a wax oil liquid and then cooling the wax oil liquid to above solidifying point;
adding the obtained premix into cooled wax oil liquid, mixing it evenly and then cooling and condensing the mixture into paste to obtain the pesticide ointment.

10. The preparation method according to claim 9, wherein the step of preparing premix further includes adding powdery pigment, stabilizing agents and/or additives alluring pests.
